(19) United States
(12) Patent Application Publication
(10) Pub. No.: US 2024/0227207 A9
(43) Pub. Date: Jul. 11, 2024

(54) TECHNIQUES FOR MATERIAL HAND-OFF USING A DOUBLE-ACTING KINEMATIC MOUNT

(71) Applicant: CORNING INCORPORATED, CORNING, NY (US)

(72) Inventor: Justin Carl Fossum, Horseheads, NY (US)

(21) Appl. No.: 18/374,886

(22) Filed: Sep. 29, 2023

Related U.S. Application Data
(60) Provisional application No. 63/417,735, filed on Oct. 20, 2022.

(51) Int. Cl. B25J 15/04; B25J 17/02

(52) U.S. Cl. CPC B25J 15/0416; B25J 15/0441; B25J 17/02

(57) ABSTRACT

Methods, systems, devices, and apparatuses that support techniques for material hand-off using a double-acting kinematic mount are described. A kinematic mount may be mounted between a flange of a robotic manipulator and with a tool for retrieval and placement of an object. The kinematic mount may include a first sub-component and a second sub-component, where a floating structure of the first sub-component may be coupled with a plate of the second sub-component by a preloading force (e.g., via one or more springs, magnets). The kinematic mount may be configured such that the floating structure may be decoupled from the plate of the second sub-component when a force greater than the preloading force is applied to a bottom plate of the first sub-component. The first sub-component may move independently of the second sub-component while decoupled, allowing the tool to align to the object during retrieval and placement.

This application claims the benefit of priority under 35 U.S.C § 120 of U.S. Provisional Application Ser. No. 63/417,735 filed on Oct. 20, 2022, the content of which is relied upon and incorporated herein by reference in its entirety.

### FIELD OF TECHNOLOGY

The present disclosure relates generally to robotic systems, and more specifically to techniques for material hand-off using a double-acting kinematic mount.

### BACKGROUND

Robotic manipulator systems may have various applications in automation, such as industrial production, medical procedures, manufacturing, machining, and assembly, where highly-repetitive procedures may be performed. In such systems, robotic manipulator systems may have different sizes and scales and may be configured to perform processes on a variety of apparatuses and systems. In some cases, precision and accuracy are highly valuable to the processes performed with robotic manipulator systems. For example, robotic manipulator systems may be implemented for precise and accurate object retrieval and placement, where the robotic manipulator systems may retrieve an object from an initial position, move the object over some distance, and place the object at a final position (e.g., the same as or different than the initial position). In some cases, however, operations of robotic manipulator systems for precise and accurate object retrieval and placement may present challenges that adversely affect operational efficiency.

### SUMMARY

The methods, apparatus, and devices of this disclosure each have several new and innovative aspects. This summary provides some examples of these new and innovative aspects, but the disclosure may include new and innovative aspects not included in this summary.

The described techniques relate to improved methods, systems, devices, and apparatuses that support techniques for material hand-off using a double-acting kinematic mount. In accordance with examples as described herein, a robotic manipulator system (e.g., a robotic arm system) may implement a kinematic mount (e.g., a double-acting kinematic mount) coupled between a flange of a robotic manipulator and an end-of-arm tooling, the kinematic mount supporting efficient operations with relatively high accuracy. The kinematic mount may include a first sub-component (e.g., a semi-floating structure) and a second sub-component (e.g., a fixed structure). The first sub-component may include a first plate (e.g., a bottom floating plate) and a floating structure (e.g., a top floating structure), and the second sub-component may include a second plate (e.g., a bottom plate of the fixed structure), as well as an outer housing and a mounting plate (e.g., a robot mount plate). The first sub-component may be coupled with the end of arm tooling via the first plate and the second sub-component is coupled with the flange of the robot manipulator via the mounting plate. The outer housing of the second sub-component at least partially surrounds the top floating structure of the first sub-component.

The top floating structure and the second plate may be coupled together by a preloading force (e.g., provided by a spring or a magnet), such that the first sub-component may not move independently of the second sub-component under some conditions, but may move independently of each other under other conditions. More specifically, the top floating structure may be decoupled from the second plate by a force (e.g., during retrieval and placement of an object) applied to a bottom surface of the first plate, where the force is greater than the preloading force and enables the first sub-component to move independently of the second sub-component. In some cases, enabling the first sub-component to move independently of the second sub-component may improve an alignment of the robotic manipulator system and the object, thereby increasing accuracy of the retrieval and placement of the object, among other advantages. In such cases, the robotic arm system may implement efficient techniques associated with fixed-location operations (e.g., picking and placing objects based on known and fixed locations and/or orientations), while also enabling the relatively high accuracy that may otherwise be associated with picking and placing objects using visual servoing (e.g., vision-based robotic control). Thus, the double-acting kinematic mount described herein may be associated with both relatively higher accuracy and increased manufacturing-time efficiency.

A method is described. The method may include obtaining an object using a tool that is coupled with a kinematic mount, the kinematic mount comprising a first sub-component and a second sub-component, wherein obtaining the object comprises: applying a force to a bottom surface of a first plate of the first sub-component, the force being greater than a preloading force that couples a top surface of a second plate of the second sub-component with a surface of a floating structure of the first sub-component, where the applied force decouples the surface of the floating structure and the top surface of the second plate and causes the tool to be positioned within a threshold distance of a first location of the object; obtaining the object while the tool is positioned within the threshold distance; and moving the object from the first location to a second location after obtaining the object.

A kinematic mount is described. The kinematic mount may include a first sub-component that comprises a first plate coupled with a floating structure; a second sub-component that at least partially surrounds the floating structure and comprises a second plate; and one or more coupling components that are configured to apply a preloading force to the first sub-component and the second sub-component, the preloading force for coupling a surface of the floating structure with a top surface of the second plate, wherein the surface and the top surface are configured to decouple when a force greater than the preloading force is applied to a bottom surface of the first plate.

A system is described. The system may include a robotic manipulator; a kinematic mount comprising a first sub-component and a second sub-component that is coupled with the robotic manipulator, the first sub-component configured to move relative to the second sub-component when a force is applied to a surface of a first plate of the first sub-component, the force being greater than a preloading force that couples a surface of a second plate of the second sub-component with a surface of a third plate of the first sub-component; and a tool coupled with the kinematic mount via a kinematic mounting base, wherein the tool is configured to: be positioned, by the robotic arm, within a threshold distance from an object based at least in part on the first sub-component moving relative to the second sub-component, and obtain the object based at least in part on the position of the tool.

### BRIEF DESCRIPTION OF THE DRAWINGS

FIGS. 1A and 1B illustrate an example of a system that supports techniques for material hand-off using a double-acting kinematic mount in accordance with examples as disclosed herein.

FIGS. 2A and 2B illustrate examples of a system and a pick-location plate that support techniques for material hand-off using a double-acting kinematic mount in accordance with examples as disclosed herein.

FIGS. 3A and 3B illustrate an example of a kinematic mount that supports techniques for material hand-off using a double-acting kinematic mount in accordance with examples as disclosed herein.

FIGS. 4A, 4B, and 4C illustrate an example of a kinematic mount that supports techniques for material hand-off using a double-acting kinematic mount in accordance with examples as disclosed herein.

FIGS. 5A, 5B, and 5C illustrate an example of a kinematic mount that supports techniques for material hand-off using a double-acting kinematic mount in accordance with examples as disclosed herein.

FIG. 6 illustrates an example of kinematic mount components that support techniques for material hand-off using a double-acting kinematic mount in accordance with examples as disclosed herein.

FIG. 7 illustrates a flow chart that supports techniques for material hand-off using a double-acting kinematic mount in accordance with examples as disclosed herein.

### DETAILED DESCRIPTION

A robotic manipulator system (e.g., a robotic arm system, a serial manipulator, a parallel manipulator) may be configured to perform one or more operations including precise retrieval and placement of objects for use in manufacturing applications. The robotic manipulator system may include an end of arm tooling (e.g., a device of the robotic manipulator system for interacting with objects) configured to retrieve an object from an initial position, move the object over some distance, and place the object at a final position (e.g., the same or different as the initial position), where precise retrieval and placement of the object may be desirable. For example, a user of the robotic manipulator system may specify a quantity of tolerances for retrieving and placing the object such that the process is accurate and highly replicable.

In some cases, manufacturing may include multiple processing stages, and robotic manipulator systems may perform one or more stages of assembly, placement, movement of objects or tools, or the like. In some cases, the robotic manipulator system may be one of many robotic manipulator systems performing manufacturing, such that each robotic manipulator system may perform one or more stages of processing. In some examples, the one or more robotic manipulator systems may perform subsequent retrievals and placements of an object (e.g., at various stage of processing), such that any misalignments (e.g., errors) in the retrievals or placements of the object may cause relatively severe misalignments at subsequent stages of processing (e.g., such as errors produced from stack tolerances). In one example, if the robotic manipulator system places an object at a location outside a tolerance (e.g., specified by the user) at a first stage of processing, the robotic manipulator system (e.g., the same robotic manipulator system or a different robotic manipulator system) may retrieve the object at the location and consequently place the object at another location further outside the tolerance at a second stage of processing.

The robotic manipulator system may implement one or more processes for aligning an end of arm tooling with an object. In some cases, robotic manipulator systems may implement visual servoing, where a visual sensor may use photoalignment processes to identify the location of the object and control the operation of the end of arm tooling for retrieval and placement of the object. For example, visual servoing may include calibrating a visual sensor frame (e.g., a camera frame) with respect to a base frame or tool frame of the robotic manipulator and capturing visual data (e.g., one or more pictures). Each time the visual data is obtained, a controller of the robotic manipulator system may use the visual data in calculating where to position the robotic manipulator system such that the end of arm tooling or the object may be positioned more precisely with respect to the object. In such cases, the accuracy of the robotic manipulator system may be limited to the resolution of the visual sensor, such that a relatively higher resolution (e.g., a relatively smaller field of view) may provide relatively greater accuracy for obtaining the visual data. Visual servoing, however, may be associated with relatively increased processing times for controlling the robotic manipulator system and end of arm tooling (e.g., due to time spent calculating inputs from the visual sensor and operating the robotic manipulator system based on an output of the calculation). Thus, visual servoing techniques may provide a relatively high degree of accuracy (e.g., ±10 micrometers (μm)) at the cost of increased manufacturing times.

In some other cases, robotic manipulator systems may implement fixed-location operation, in which the location and/or orientation of the object is predetermined, and the robotic manipulator system operates according to the predetermined location and orientation. Such fixed-location operation may be associated with a relatively lower degree of accuracy (e.g., ±100 μm), but may benefit from relatively faster operation (e.g., due to not having to perform calculations based on the visual sensor, as typically associated with visual servoing techniques). In some instances, however, an object may not be in the predetermined location and orientation prior to retrieval or after placement (e.g., due to relative inaccuracies with the operation of the robotic manipulator system), which may introduce one or more errors in the subsequent stages of processing. Therefore, there is a desire to operate robotic manipulator systems such that a high degree of accuracy (e.g., typically associated with visual servoing) is achieved while maintaining relatively high manufacturing time efficiency (e.g., typically associated with fixed location operation). Put another way, operating a robotic manipulator with the speed of fixed location techniques and the accuracy associated with visual servoing (but without using visual servoing) may improve manufacturing efficiency and output, among other advantages.

In accordance with examples described herein, a robotic manipulator system may implement a kinematic mount (e.g., a double-acting kinematic mount) between a flange of a robotic manipulator and an end of arm tooling to provide high accuracy, decreased processing times, and improved efficiency, for example, in various manufacturing processes. The kinematic mount may include a semi-floating structure (e.g., a first sub-component) and a fixed structure (e.g., a second sub-component). The semi-floating structure may include a bottom floating plate (e.g., a first plate) that is coupled with end of arm tooling (e.g., the end of arm tooling may be mechanically mounted to the bottom floating plate). Further, the fixed structure may include a bottom plate (e.g., a second plate), a housing, and a mounting plate (e.g., a robot mounting plate) that are coupled together, where a flange of the robotic manipulator may be coupled with the kinematic mount via the mounting plate. Further, the semi-floating structure may include a top floating structure that is surrounded (e.g., at least partially surrounded) by the housing and is coupled with the bottom floating plate (e.g., the semi-floating structure may comprise a solid body, where the top floating structure and the bottom floating plate are connected via one or more mechanical fasteners). A surface of the top floating structure and a top surface of the bottom plate of the fixed structure (e.g., the second plate) may be coupled together by a preloading force (e.g., applied by a spring, or a magnet, or the like), such that the semi-floating structure may not move independently of the fixed structure when the top floating structure and the second plate are coupled by the preloading force.

In some aspects, the top floating structure, however, may be decoupled from the bottom plate by an applied force (e.g., via retrieval or placement of an object) greater than the preloading force, enabling the semi-floating structure to move independently of the fixed structure (e.g., within the fixed structure). In some cases, enabling the semi-floating structure to move independently of the fixed structure, may mitigate errors in the alignment of the robotic manipulator system and the object, thereby increasing accuracy of the retrieval and placement of the object. In such cases, robotic manipulator systems utilizing the double-acting kinematic mount described herein may benefit from the time efficiency associated with fixed location operation, while achieving the relatively high accuracy typically associated with visual servoing. In some aspects, the described kinematic mount may enable object picking and/or placement with accuracy of ±1.0 μm. Thus, the kinematic mount described herein may be associated with improved accuracy and high manufacturing time efficiency.

Aspects of the disclosure are initially described in the context of a system that supports techniques for material hand-off using a double-acting kinematic mount. Aspects of the disclosure are further illustrated by and described with reference to systems, devices, and flowcharts that relate to methods and apparatuses for performing the described techniques.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally or alternatively solve other problems than those described herein. Further, aspects of the disclosure may provide technical improvements to “conventional” systems or processes as described herein. However, the description and appended drawings include example technical improvements resulting from implementing aspects of the disclosure, and accordingly do not represent all of the technical improvements provided within the scope of the claims.

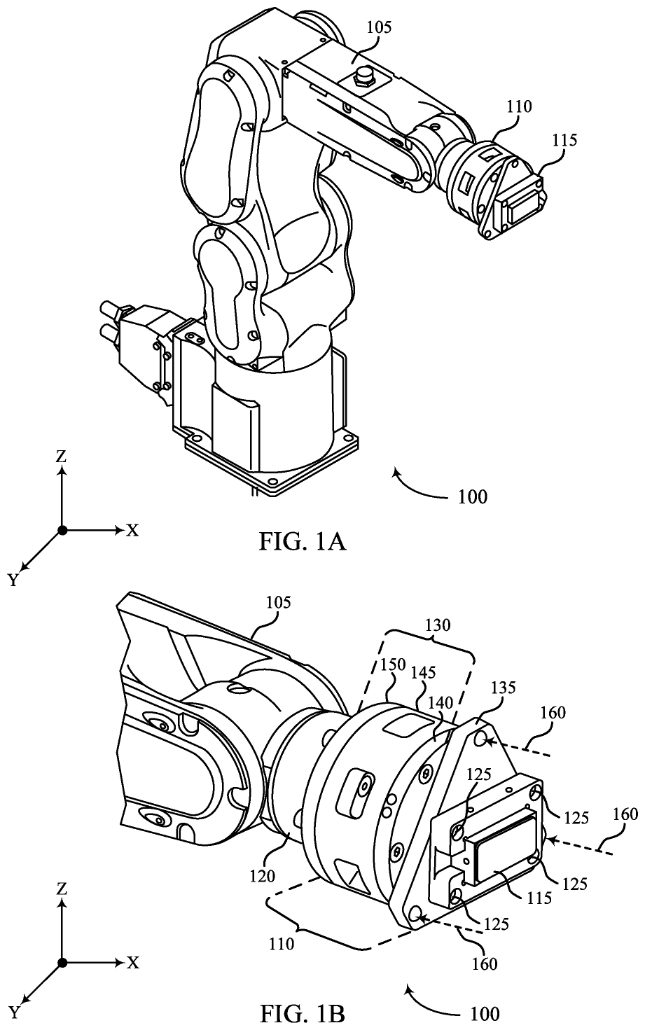

FIGS. 1A and 1B illustrate an example of a system 100 that supports techniques for material hand-off using a double-acting kinematic mount in accordance with examples as disclosed herein. For example, FIGS. 1A and 1B illustrate isometric views of a system 100 (e.g., a robotic manipulator system) that includes a robotic manipulator 105 (e.g., a robotic arm), a kinematic mount 110, and an end of arm tooling 115. Although FIGS. 1A and 1B illustrate examples of relative dimensions and quantities of various features, aspects of the system 100, the robotic manipulator 105, the kinematic mount 110, and/or the end of arm tooling 115 may be implemented with other relative dimensions or quantities of such features in accordance with examples as disclosed herein. In some cases, robotic manipulator systems, such as the system 100, may be configured to perform one or more operations in manufacturing applications including, for example, precise retrieval and placement of an object.

The robotic manipulator 105 may be controlled by one or more control systems (e.g., one or more programmable logic controllers, or the like) that may be configured to operate, for example, one or more joints of the robotic manipulator (e.g., via respective potentiometers or other components) to move an object to a specified location and/or along a predetermined path. The one or more control systems may be programmed prior to performing an operation (e.g., a specified movement) or operated by a user to perform an operation using the system 100, or any combination thereof. In some aspects, the robotic manipulator 105 may be an example of a serial manipulator (e.g., comprising a series of links connected by motor-actuated joints) or a parallel manipulator (e.g., a manipulator where an end effector may be connected to the manipulator by a quantity of separate linkages that operate simultaneously), among other examples.

The end of arm tooling 115 (e.g., a device of the robotic manipulator system for interacting with objects, which may be referred to herein as a tool, end effector, or other terminology), may be configured to retrieve an object from an initial position and place the object at a final position, for example, when the robotic manipulator moves the object from the initial position to the final position. For instance, the end of arm tooling 115 may be an example of one or more tools that are configured to retrieve an object and place the object, among other examples. The end of arm tooling 115 may include grippers, vacuum tools (e.g., shown), sensors, material removal components, welding components, hydraulically-powered tools, pneumatically-powered tools, mechanically-powered tools, among other examples, or combinations thereof. In any case, precise retrieval and placement of an object using the system 100 may be desirable. For example, a user of the system 100 may specify a quantity of tolerances (e.g., stage tolerances and stack tolerances, such as less than 20 μm) for retrieving and placing the object such that the process is accurate and highly replicable.

The system 100 may perform subsequent retrievals and placements of the object (e.g., at different stages of processing), such that misalignments (e.g., errors) in the retrievals or placements of the object may potentially cause further (potentially greater) misalignments (e.g., such as errors produced from stack tolerances) at subsequent stages of processing. In some cases, if an object is placed at a location outside a tolerance (e.g., as specified by the user) at a first stage of processing, then one or more subsequent stages of processing associated with the object may be affected. Thus, precise object placement using a robotic manipulator 105, in addition to speed, may be an important aspect of various manufacturing processes.

In some cases, visual servoing and fixed location operation may be used for object placement and retrieval. In visual servoing, a visual sensor may use photoalignment processes to control the operation of the end of arm tooling for retrieval and placement of the object accordingly. The visual servoing method may provide a relatively high degree of accuracy (e.g., ±10 μm), but may suffer from increased processing times (e.g., due to computations associated with images taken for the photoalignment processes). In fixed location operation, the location and orientation of the object is predetermined and the system operates according to the predetermined location and orientation. The fixed location operation may provide a relatively lower degree of accuracy (e.g., ±100 μm) compared to visual servoing, but may be associated with relatively faster operation (e.g., due to not having to perform computations, as in visual servoing techniques). Therefore, operating the system 100 such that a high degree of accuracy (e.g., typically achieved with visual servoing) is achieved while maintaining high manufacturing efficiency (e.g., associated with fixed location operation) is desirable.

In accordance with examples described herein, the system 100 may implement the kinematic mount 110 coupled between the robotic manipulator 105 and an end of arm tooling 115, where the kinematic mount 110 supports relatively high accuracy and improved efficiency. More specifically, and as illustrated in further detail by FIG. 1B, the robotic manipulator 105 may include one or more flanges 120 that are coupled with the kinematic mount 110. In some aspects, the kinematic mount 110 may be removably connected to a flange 120 of the robotic manipulator 105. For instance, the kinematic mount 110 may be connected to the flange 120 of the robotic manipulator 105 via one or more mechanical fasteners, a universal mount, or other techniques. In some examples, the kinematic mount 110 may be configured for mounting to a flange 120 of various types (e.g., multiple different manufacturer, models) of robotic manipulators 105. Similarly, the end of arm tooling 115 may be removably connected to the kinematic mount 110 via various means, including mechanical fasteners, magnetic mounting, a universal mount, or other techniques. As illustrated, multiple fasteners 125 may couple the end of arm tooling 115 to the kinematic mount 110.

The kinematic mount 110 may include various sub-components. For example, and as described in further detail below, the kinematic mount may include a fixed structure 130 and a semi-floating structure (part of which is internal to the fixed structure 130 and described in further detail below) that includes a bottom floating plate 135. The end of arm tooling 115 may be coupled with a bottom surface of the bottom floating plate 135. The fixed structure 130 may include a bottom plate 140 (e.g., a second plate), a housing 145 (e.g., an outer housing) that houses or at least partially surrounds a top floating structure of the semi-floating structure, and a mounting plate 150 (e.g., a robotic mounting plate). As illustrated, the flange 120 of the robotic arm manipulator 105 is mounted to the kinematic mount 110 via the mounting plate 150.

In some aspects, the respective sub-components of the kinematic mount 110 may be coupled (e.g., the semi-floating structure and the fixed structure 130 of the kinematic mount are coupled together) by a preloading force, such that the fixed structure 130 and the semi-floating structure may not move independently. In such implementations, the kinematic mount 110 may not allow the end of arm tooling 115 to move (e.g., positionally, rotationally) independently with respect to the flange 120 of the robotic manipulator 105. For example, when the robotic manipulator 105 is not actively performing operations on an object, the end of arm tooling 115 may not move independent of the flange 120 due to the kinematic mount 110 acting as a solid body. Thus, when the sub-components of the kinematic mount 110 are coupled, the system 100 may operate with a fixed frame of reference.

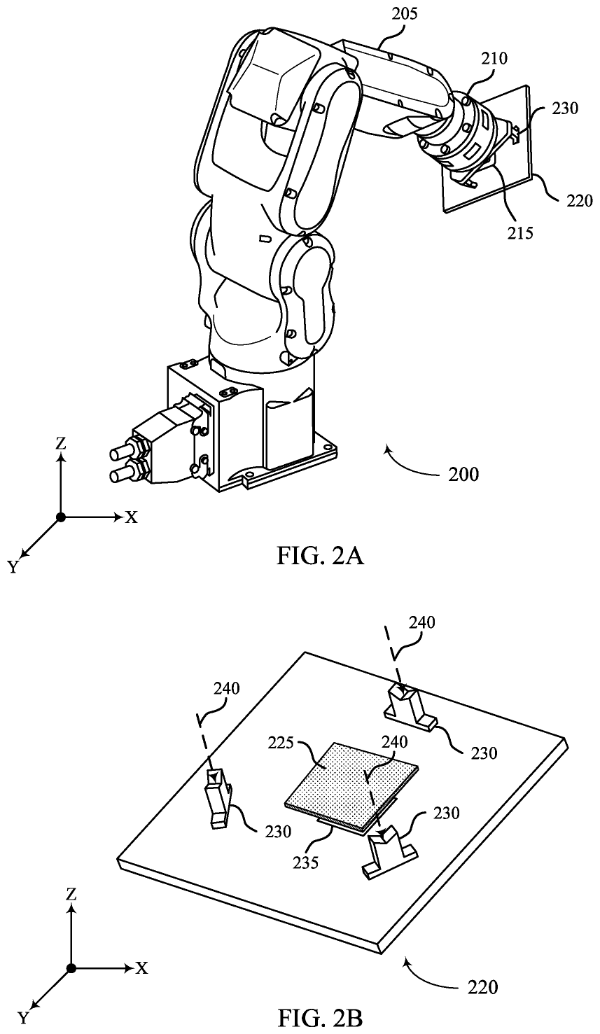

In some aspects, the respective sub-components of the kinematic mount 110 may be decoupled (e.g., the semi-floating structure and the fixed structure 130 of the kinematic mount 110 may be decoupled) by a force (e.g., an external force, as illustrated by arrows 160) applied to the bottom surface of the bottom floating plate 135, such that the kinematic mount 110 may allow the semi-floating structure (including bottom floating plate 135) and the end of arm tooling 115 to move independently of the flange 120 of the robotic manipulator 105. The applied force may be a force associated with retrieving an object or placing an object, among other examples. For example, and as described in further detail below with respect to FIGS. 2A and 2B, the robotic manipulator 105 may retrieve the object from a surface, and the force applied by the robotic manipulator 105 on the object and vice versa may cause the kinematic mount 110 to decouple. In some cases, when the respective sub-components of the kinematic mount 110 are decoupled, the end of arm tooling 115 may move with six (6) degrees of freedom, thereby enabling the system 100 to act as two solid bodies (e.g., the robotic manipulator 105 and the end of arm tooling 115).

Selectively decoupling the sub-components of the kinematic mount 110 by applying a force to the surface of the bottom floating plate 135 may allow the system 100 to mitigate errors associated with performing fixed location operation. In particular, an object to be moved may have a predetermined location known by the system 100, and the system 100 may operate to retrieve the object according to the predetermined location regardless of tolerance errors associated with the predetermined location. Any positioning or location errors that exist may not be propagated to subsequent stages of processing because the decoupling of the kinematic mount 110 may mitigate the errors in the tolerance. Here, the kinematic mount 110 may allow the system 100 to act on the predetermined location by aligning the end of arm tooling 115 to the predetermined location when the force is applied to the bottom floating plate 135 (thereby decoupling the semi-floating structure from the fixed structure 130, enabling independent movement of the semi-floating structure). Such decoupling results in an alignment of the end of arm tooling 115 with the object. In some examples, temporarily decoupling the sub-components of the kinematic mount 110 may transfer the “master” (the component controlling the positional accuracy of the object) from the robotic manipulator 105 to the end of arm tooling 115. Therefore, the end of arm tooling 115 may retrieve and/or place the object regardless of a tolerance error associated with the predetermined location or operations in between retrieval and placement that may be otherwise associated with the robotic manipulator 105 being the “master.”.

Particular aspects of the subject matter described herein may be implemented to realize one or more of the following potential advantages. For example, the kinematic mount 110 allows the robotic manipulator 105 to have relatively high accuracy and high efficiency, where the kinematic mount 110 may support positional accuracy up to ±1 μm, while maintaining the speed, production volume, and efficiency associated with low accuracy methods (e.g., fixed location operation). That is, using the kinematic mount 110 with existing robotic manipulators 105 provides positional accuracies within 1 μm of a desired placement, and the passive configuration of the kinematic mount 110 enhances manufacturing operations without adding complexity to systems 100 (e.g., the decoupling of sub-components of the kinematic mount 110 is achieved through an external force that is already present in picking and placement operations). Further, as described herein, the kinematic mount 110 enables high-precision part picking, handling, pass off, placing, and repicking while using techniques associated with fast, large work volume, industrial robots that may otherwise have relatively low accuracy (e.g., without the use of the kinematic mount 110). In some aspects, operation of the kinematic mount 110 may not be associated with additional time or power, and the kinematic mount 110 may improve locational accuracies (e.g., by up to 100 times). In some cases, a robotic manipulator 105 may implement multiple kinematic mounts 110, where the robotic manipulator 105 may support multiple tools associated with respective kinematic mounts 110. As an example, a robotic manipulator 105 may include multiple (e.g., two) kinematic mounts 110 corresponding to respective tools and having some offset between each tool (e.g., a 60 degree offset), which may be used for simultaneous part picking and/or placement, part picking and/or placement at different locations, among other examples.

FIGS. 2A and 2B illustrate an example of a system 200 and a pick-location plate 220, respectively, that support techniques for material hand-off in accordance with examples as disclosed herein. For example, FIG. 2A illustrates an isometric view of a system 200 (e.g., a robotic manipulator system) that includes a robotic manipulator 205 (e.g., a robotic arm), a kinematic mount 210, and an end of arm tooling 215. The system 200 may be an example of the system 100 described with reference to FIGS. 1A and 1B. For instance, the robotic manipulator 205, the kinematic mount 210, and the end of arm tooling 215 may be an example of the corresponding components and devices described with reference to FIGS. 1A and 1B. Although FIGS. 2A and 2B illustrate examples of relative dimensions and quantities of various features, aspects of the system 200, the robotic manipulator 205, the kinematic mount 210, and/or the end of arm tooling 215 may be implemented with other relative dimensions or quantities of such features in accordance with examples as disclosed herein.

In some cases, the system 200 may be configured to perform one or more operations in manufacturing applications including, for example, precise retrieval and placement of an object. In particular, the system 200 implements the kinematic mount 210 (e.g., a double-acting kinematic mount) between a flange (such as a flange 120 described with reference to FIG. 1B) of the robotic manipulator 205 and the end of arm tooling 215 to provide high accuracy, decreased processing times, and improved efficiency. As described herein, the kinematic mount 210 may include a semi-floating structure (e.g., a first sub-component) and a fixed structure (e.g., a second sub-component, such as the fixed structure 130 described with reference to FIG. 1B). The semi-floating structure may include a bottom floating plate (e.g., a bottom floating plate 135 described with reference to FIG. 1B) that is coupled with the end of arm tooling 215. Further, the fixed structure may include a bottom plate, a housing, and a mounting plate (e.g., a bottom plate 140, a housing 145, and a mounting plate 150, as described with reference to FIG. 1B), where a flange of the robotic manipulator may be coupled with the kinematic mount via the mounting plate. Further, the semi-floating structure may include a top floating structure (not shown in FIG. 1B) that is surrounded (e.g., at least partially surrounded) by the housing and is coupled with the bottom floating plate. As described herein, a surface of the top floating structure and a surface of the bottom plate of the fixed structure may be coupled together by a preloading force, such that the semi-floating structure may not move independently of the fixed structure when the top floating structure and the second plate are coupled by the preloading force. Further the surface of the top floating structure may be decoupled from the bottom plate by an applied force (e.g., via retrieval or placement of an object) greater than the preloading force, enabling the semi-floating structure to move independently of the fixed structure. As such, when the semi-floating structure moves independently of the fixed structure, errors in the alignment of the robotic manipulator 205 and an object may be mitigated, thereby increasing accuracy of the retrieval and placement of objects.

As an illustrative example, the robotic manipulator may be operated to be positioned over a pick-location plate 220 to obtain an object 225. As illustrated by FIG. 2B, the object 225 may be positioned on the pick-location plate 220 with some predetermined orientation and a location that may correspond to an indexed location of the object 225. That is, the pick-location plate 220 may be coupled with a surface at the location of the object and may be associated with the precise location of the object.

In some aspects, the pick-location plate 220 may include three or more extensions 230 that are configured to further align the kinematic mount 210 (e.g., the bottom floating plate of the kinematic mount 210, and with it, the end of arm tooling 215) with the object 225. More specifically, the extensions 230 may be examples of or include kinematic coupling elements that are configured to interact with one or more corresponding kinematic coupling elements on a surface of the bottom floating plate of the kinematic mount 210. In some examples, the extensions 230 may include v-grooves for mating with spherical kinematic coupling elements (e.g., spherical protrusions) positioned on a bottom surface of the bottom floating plate of the kinematic mount 210. Other types or designs of kinematic coupling elements may be used for the extensions 230 and the corresponding kinematic coupling elements on the bottom floating plate. In any case, the extensions 230 may be positioned (e.g., spaced, located) around the pick-location plate 220 such that the extensions 230 may be aligned with the kinematic coupling elements of the kinematic mount 210 when using the robotic manipulator 205.

In some aspects, the pick-location plate 220 may include one or more holding structures 235 on the surface of the pick-location plate 220. Such holding structures 235 may be used to hold the object 225 before it is picked (e.g., by the end of arm tooling 215) with some position and orientation. Similarly, the object 225 may be placed in the holding structure 235 when placed onto the pick-location plate 220 (e.g., by the end of arm tooling 215). The holding structure 235 may comprise a protrusion that enables the object 225 to be seated using corresponding geometries of the holding structure 235 and the object 225 (e.g., a rectangular shape is shown, but other shapes are possible). The holding structure 235 may be attached to the surface of the pick-location plate 220 or may be included as part of the pick-location plate (e.g., the pick-location plate may be machined with one or more holding structures 235).

The robotic manipulator 205 may be operated to position and align the end of arm tooling 215 (and the kinematic mount 210) with some degree of precision that is supported by the system 200. In such cases, the robotic manipulator may continue to move the end of arm tooling 215 and kinematic mount 210 closer to the extensions 230 of the pick-location plate 220 in order to obtain the object 225. Here, the kinematic coupling elements on the bottom surface of the bottom floating plate of the kinematic mount 210 may be aligned with, and come into contact with the extensions 230, as illustrated by arrows 240. After the kinematic mount 210 makes contact with the extensions 230, and as the robotic manipulator continues to press the kinematic mount 210 into the extensions 230, a force that is greater than the preloading force may be applied by the extensions 230 to the bottom surface of the bottom floating plate. This force may result in the semi-floating structure and the fixed structure of the kinematic mount 210 decoupling and moving independently of one another, which may enable further degrees of freedom for aligning the end of arm tooling 215 with the object 225. In such cases, the semi-floating structure of the kinematic mount 210 and the end of arm tooling 215 may continue to be positioned relatively more accurately with respect to the precise location of the object 225, enhancing the ability of the system to accurately (e.g., within 1 μm) and efficiently pick the object 225 using the end of arm tooling 215.

When the object 225 is obtained and picked up by the end of arm tooling 215, the robotic manipulator may move the end of arm tooling 215 (e.g., now holding the object) and the kinematic mount 210 away from the pick-location plate 220, which may decrease the force placed on the surface of the bottom floating plate of the kinematic mount 210 by the extensions 230. When the force is decreased to a value that is less than the preloading force, the semi-floating structure and the fixed structure of the kinematic mount 210 may re-couple, thereby resuming what is effectively a solid-body configuration while the object is moved to another location (e.g., the semi-floating structure and the fixed structure of the kinematic mount 210 may not move independently on one another). Further, the aforementioned process may be similarly enabled when the object 225 is placed at a second location, where some structures or extrusions (e.g., on a corresponding place-location plate) may provide a force to the bottom floating plate of the kinematic mount 210 that exceeds the preloading force, decoupling the semi-floating structure and the fixed structure for enhanced alignment through additional degrees of freedom.

Passively coupling and decoupling the kinematic mount 210 by applying a force from the pick-location plate 220 (e.g., by the extensions 230 of the pick-location plate 220) may allow the system 200 to mitigate errors associated with performing retrieval and placement of the object 225. For example, tolerance errors associated with a predetermined location of the object 225 may not be propagated to subsequent stages of processing because the decoupling of the kinematic mount 210 may mitigate the errors and provide improved accuracy for object placement and/or retrieval. The kinematic mount 210 may allow the robotic manipulator 205 to act on the predetermined location by an initial alignment of the end of arm tooling 215 to the predetermined location (e.g., within about 100 μm) and then enabling the kinematic mount 210 to decouple and further align the end of arm tooling to the object (e.g., the actual location of the object) with increased accuracy. Therefore, the end of arm tooling 215 may retrieve and place the object 225 regardless of a tolerance error associated with the predetermined location or operations in between retrieval and placement. Further, the kinematic mount 210 may allow the system 200 to have high accuracy and high efficiency. For example, the kinematic mount 210 may support positional accuracy up to ±1 μm due to the self-aligning mechanics of the kinematic mount 210, while maintaining the speed, production volume, and efficiency typically associated with lower accuracy methods (e.g., fixed location operation). In some implementations, operation of the kinematic mount 210 may improve positional accuracy by 100 times (e.g., compared to fixed location operation), without causing an increase to time or power consumption during manufacturing.

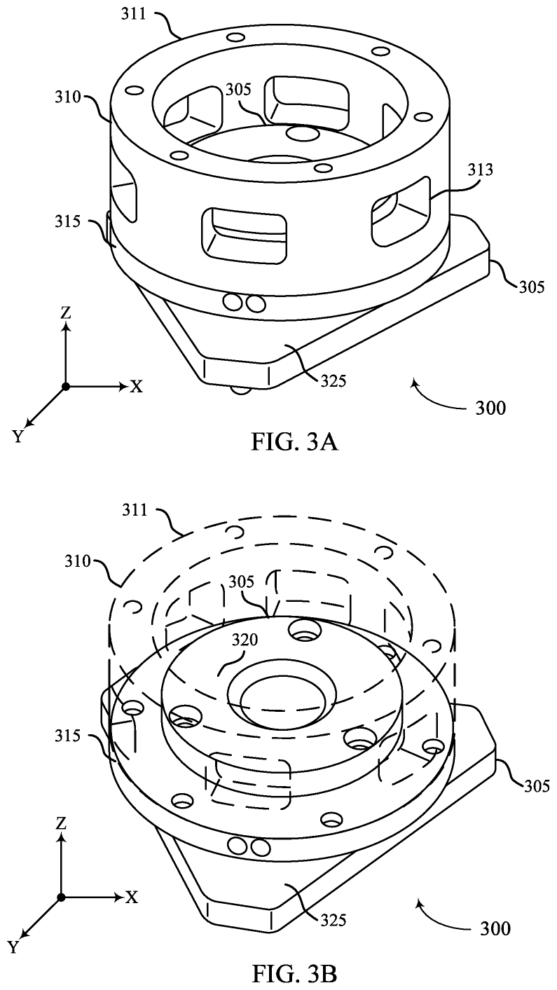

FIGS. 3A and 3B illustrate an example of a kinematic mount 300 that supports techniques for material hand-off using a double-acting kinematic mount in accordance with examples as disclosed herein. The kinematic mount 300 may be an example of the kinematic mount 110 and the kinematic mount 210 described with reference to FIGS. 1A, 1B, 2A, and 2B. For illustrative purposes, aspects of the kinematic mount 300 may be described with reference to a x-direction, a y-direction, and a z-direction of the illustrated coordinate system. For example, FIGS. 3A and 3B illustrate an isometric view of the kinematic mount 300. Although FIGS. 3A and 3B illustrate examples of relative dimensions and quantities of various features, aspects of the kinematic mount 300 may be implemented with other relative dimensions or quantities of such features in accordance with examples as disclosed herein.

In accordance with examples described herein, a robotic manipulator system may include the kinematic mount 300 between a flange of the robotic manipulator system and an end of arm tooling that supports relatively high accuracy and improved efficiency. The kinematic mount 300 may include a semi-floating structure 305 (e.g., a first sub-component) and a fixed structure 310 (e.g., a second sub-component).

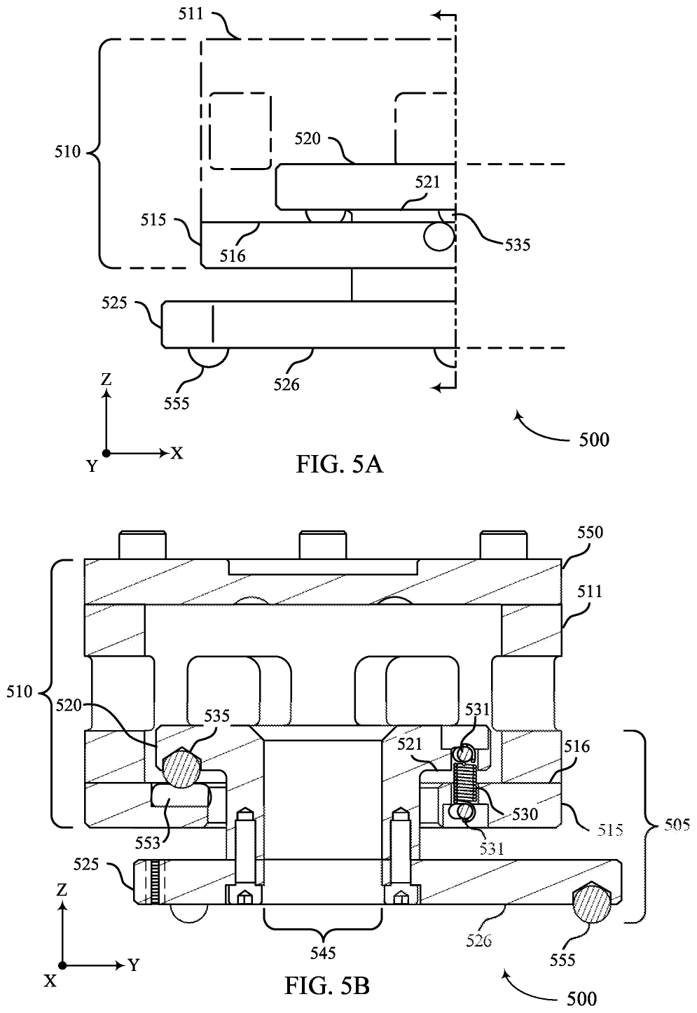

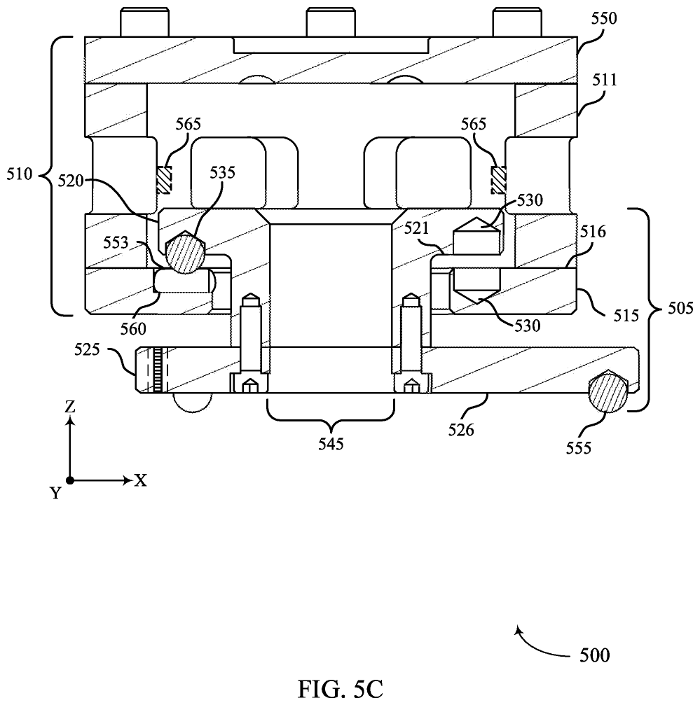

The semi-floating structure 305 may be coupled with the fixed structure 310 by a preloading force (e.g., a force for coupling a surface of the semi-floating structure 305 with a bottom plate 315 of the fixed structure 310, which may be counter to externally-applied forces acting to free the semi-floating structure 305 from the fixed structure 310). As such, the semi-floating structure 305 may not move independently of the fixed structure 310. As described in further detail with reference to FIGS. 5B and 5C, the preloading force may be applied by one or more coupling components (e.g., springs, magnets, or other components and devices). In addition, the semi-floating structure 305 may be decoupled from the fixed structure 310 by an applied force (e.g., an external force), such that the semi-floating structure 305 may move (e.g., positionally, rotationally) independently of the fixed structure 310. The applied force may be a force associated with retrieving or placing an object, among other examples, and as described with reference to FIGS. 1B, 2A, and 2B.

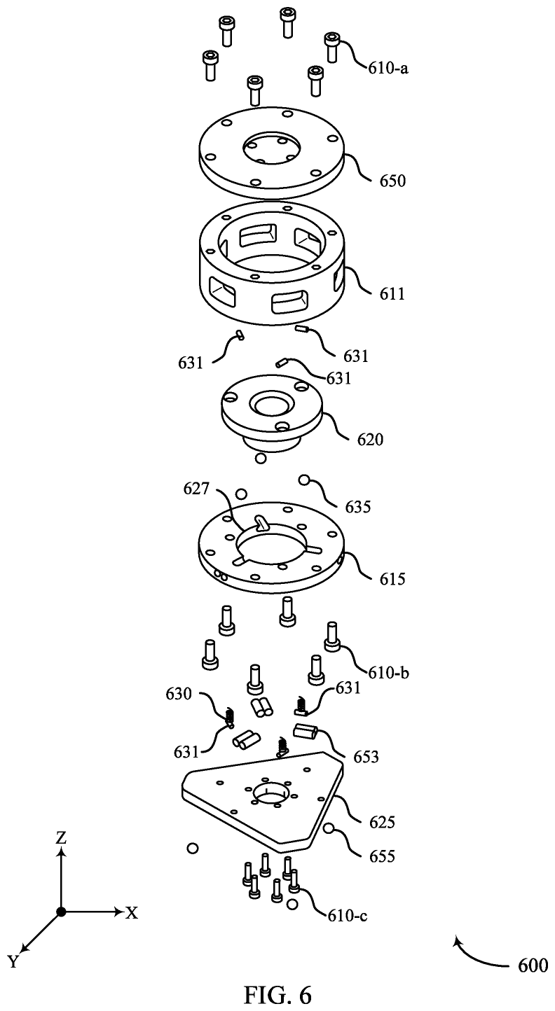

In some embodiments, the semi-floating structure 305 may include a top floating structure 320 that is coupled with a bottom floating plate 325 (e.g., a first plate). In some cases, and described in further detail below with reference to FIG. 6, the top floating structure 320 may be coupled to the bottom floating plate 325 via mechanical fasteners (e.g., via screws), for example, along the z-direction and connecting the top floating structure 320 to the bottom floating plate 325.

The bottom plate 315 (e.g., a second plate) may be mechanically connected (e.g., via screws) to a housing 311 (e.g., an outer housing, which is transparent in FIG. 3B). In some cases, the housing 311 may optionally include one or more openings 313 (e.g., holes, windows) located concentrically around the housing 311, which may provide access (e.g., electrical access, connection access for one or more other components) to the semi-floating structure 305 or the fixed structure 310.

The bottom plate 315 may be located above the bottom floating plate 325 and surround at least a portion of the top floating structure 320 (e.g., a portion of the top floating structure 320 that extends downward in the z-direction and couples to the bottom floating plate 325). The housing 311 of the fixed structure 310 may at least partially surround the top floating structure 320. For example, the top floating structure 320 may be concentric with the bottom plate 315 and partially enclosed within the housing 311. The bottom plate 315 may accordingly have an opening in the xy-plane that enables the top floating structure 320 to pass through the bottom plate 315 in the z-direction. Thus, when the surface of the top floating structure 320 is decoupled from the bottom plate 315, the semi-floating structure 305 may be able to move along the z-direction at a distance confined by the top floating structure 320 and/or the bottom floating plate 325. Similarly, the semi-floating structure 305 may move along the x-direction and/or the y-direction at a distance confined by the fixed structure 310 (e.g., the housing 311 and/or the opening in the bottom plate 315) when the surface of the top floating structure 320 is decoupled from the bottom plate 315. In addition, when the surface of the top floating structure 320 is decoupled from the bottom plate 315, the semi-floating structure 305 may rotate along any of the x-axis, y-axis, and z-axis to a degree, which, in some embodiments, may be confined by the physical structure of the fixed structure 310.

Selectively decoupling the semi-floating structure 305 and the fixed structure 310 by applying a force to the semi-floating structure 305 may allow the robotic manipulator system to mitigate errors associated with performing fixed location operation. For example, the object may have a predetermined location known by the robotic manipulator system, and the robotic manipulator system may operate according to the predetermined location regardless of tolerance errors associated with the predetermined location. However, the errors may not be propagated to subsequent stages of processing because the decoupling of the kinematic mount 300 may mitigate the errors in the tolerance. The kinematic mount 300 may allow the robotic manipulator system to act on the predetermined location by aligning the fixed structure 310 to the predetermined location and allowing a surface of the semi-floating structure 305 to temporarily decouple from the fixed structure 310 and align the end of arm tooling with the object (e.g., the actual location of the object). In some examples, temporarily decoupling the surface of the top floating structure 320 from the bottom plate 315 may transfer the “master” (the component controlling the positional accuracy of the object) from the fixed structure 310 to the semi-floating structure 305. Therefore, when decoupled, the semi-floating structure 305 may enable accurate retrieval and placement of the object regardless of a tolerance error associated with the predetermined location or operations in between retrieval and placement that may be otherwise associated with the fixed structure 310 being the “master” of the solid body.

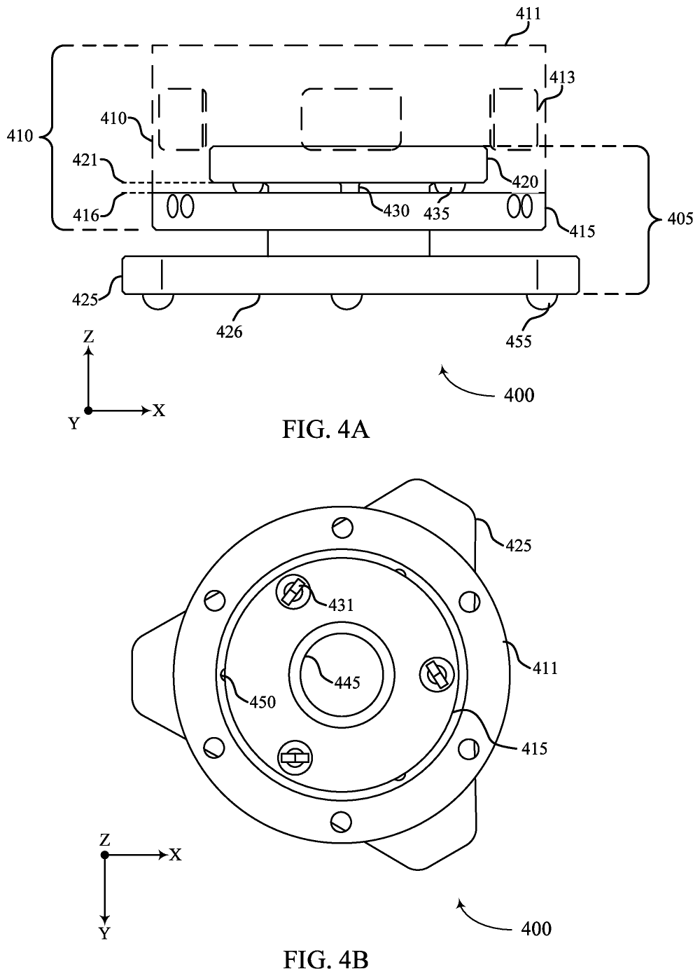

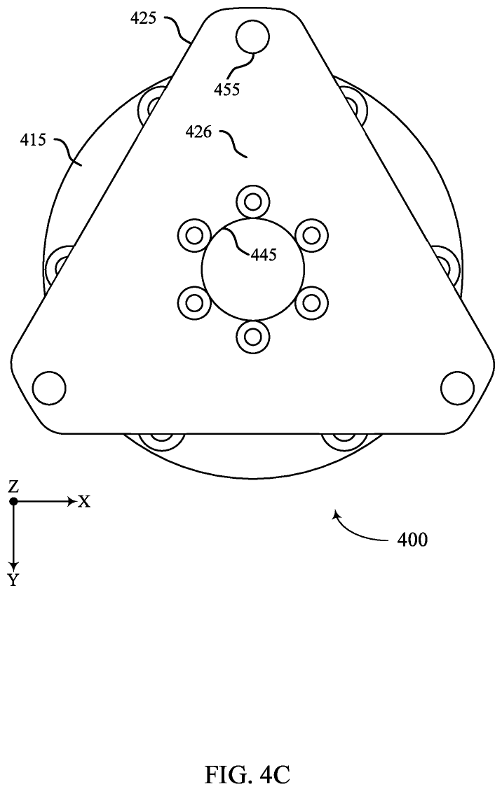

FIGS. 4A, 4B, and 4C illustrate an example of a kinematic mount 400 that supports techniques for material hand-off using a double-acting kinematic mount in accordance with examples as disclosed herein. The kinematic mount 400 may be an example of the kinematic mount 110, the kinematic mount 210, and the kinematic mount 300 described with reference to FIGS. 1A, 1B, 2A, 2B, 3A, and 3B. For illustrative purposes, aspects of the kinematic mount 400 may be described with reference to an x-direction, a y-direction, and a z-direction of the illustrated coordinate system. For example, FIG. 4A illustrates a side view of the kinematic mount 400, where the kinematic mount 400 is shown in an xz-plane, with features of the kinematic mount 400 extending some distance along the y-axis (e.g., into the page). FIG. 4B illustrates a top view of the kinematic mount 400, where the kinematic mount 400 is shown in an xy-plane, with features of the kinematic mount 400 extending some distance along the z-axis (e.g., into the page). FIG. 4C illustrates a bottom view of the kinematic mount 400, where the kinematic mount 400 is shown in an xy-plane, with features of the kinematic mount 400 extending some distance along the z-axis (e.g., into the page). Although FIGS. 4A, 4B, and 4C illustrate examples of relative dimensions and quantities of various features, aspects of the kinematic mount 400 may be implemented with other relative dimensions or quantities of such features in accordance with examples as disclosed herein. The kinematic mount 400 as described herein may mount between a flange of a robotic manipulator system and an end of arm tooling for the accurate and efficient retrieval and placement of an object.

The kinematic mount 400 may include a semi-floating structure 405 (e.g., a first sub-component) and a fixed structure 410 (e.g., a second sub-component), which may be examples of a semi-floating structure 305 and a fixed structure 310 as described with reference to FIGS. 3A and 3B, respectively. The semi-floating structure 405 may include a top floating structure 420 and a bottom floating plate 425 (e.g., a first plate), where the top floating structure 420 and the bottom floating plate 425 are coupled together (e.g., by one or more fasteners through the top floating structure 420 or the bottom floating plate 425, or both).

The fixed structure 410 may include a bottom plate 415 (e.g., a second plate) connected to a housing 411 (e.g., transparent in FIG. 4A). The bottom plate 415 may be an example of the bottom plate 140 or the bottom plate 315 described with reference to FIGS. 1B, 3A, and 3B. In some aspects, the housing 411 may optionally have some quantity of openings 413 (e.g., for electrical or other types of access). In some cases, the bottom plate 415 may be connected to the housing 411 via one or more fasteners (e.g., screws) (e.g., located concentrically and equally spaced around the outer housing) through the housing 411. In some cases, the top floating structure 420 and the bottom plate 415 may be cylindrical shaped, and the bottom floating plate 425 may be triangular shaped.

The fixed structure 410 may further include a mounting plate (such as a mounting plate 150 described with reference to FIG. 1B) configured to mount to a flange of the robotic manipulator. In some embodiments, a top surface of the mounting plate of the fixed structure 410 may mount to the flange of the robotic manipulator system via one or more fasteners (e.g., screws) or other mechanical means.

As described herein, the semi-floating structure 405 may be coupled with the fixed structure 410 by a preloading force which may be an example of a preloading force as described with reference to FIGS. 1A, 1B, 2B, 3A, and 3B. For example, the preloading force may act to couple opposite surfaces of the components of the semi-floating structure 405 and the fixed structure 410 and may be applied by one or more coupling components 430. Specifically, a surface 421 of the top floating structure 420 may be coupled with a top surface 416 of the bottom plate 415 via the one or more coupling components 430.

The one or more coupling components 430 may extend at least partially through the top floating structure 420 and the bottom plate 415 and may apply the preloading force to couple the semi-floating structure 405 and the fixed structure 410. The one or more coupling components 430 may include, for example, three or more components, as discussed further below, that may constrain the movement of the semi-floating structure 405 to the fixed structure against six (6) degrees of freedom. In some implementations, the one or more coupling components 430 may apply the preloading force in the opposite direction of an external force such that, when the external force is removed, the semi-floating structure 405 and the fixed structure 410 return to a coupled state.

In some embodiments, and as described in further detail with reference to FIGS. 5B and 5C, the one or more coupling components 430 may include one or more springs, or one or more magnets, or any combination thereof. For example, a spring may be connected to the top floating structure 420 and the bottom plate 415, such that the spring may apply a force pulling the top floating structure 420 and the bottom plate 415 together. In such examples, the spring may be one of multiple springs mounted concentrically around the top floating structure 420 and the bottom plate 415, or one spring concentric to and surrounding the top floating structure 420 (not shown). In some aspects, the one or more springs may each extend from the top floating structure 420 to the bottom plate 415 in the xy-plane, and the springs may be spaced apart radially along a radial direction of the mount.

In some implementations, the one or more springs may each be connected to the top floating structure 420 by a first pin 431, for example, located at least partially within the top floating structure 420, and connected to the bottom plate 415 by a second pin (not shown) located at least partially within the bottom plate, such that the one or more springs extend at least partially through the top floating structure 420 and the bottom plate 415 in the z-direction. In another embodiment, coupling components 430 may comprise a magnet on the top floating structure 420 and a corresponding magnet on the bottom plate 415. The magnet of the top floating structure 420 may be oriented such that the corresponding magnet of the bottom plate 415 may have an attractive force for coupling the top floating structure 420 and the bottom plate 415 together.

In some cases, the preloading force may be applied by the coupling components 430 such that the preloading force is affected by the distance between the top floating structure 420 and the bottom plate 415. For example, if the coupling components 430 are implemented as one or more springs, the preloading force may be proportionally related to the distance between the top floating structure 420 and the bottom plate 415, such that the one or more springs may exert comparatively more force to couple the top floating structure 420 and the bottom plate 415 as the distance between the top floating structure 420 and the bottom plate 415 increases, and comparatively less force to couple the top floating structure 420 and the bottom plate 415 as the distance between the top floating structure 420 and the bottom plate 415 decreases. If the coupling components 430 are implemented as one or more magnets, the preloading force may be inversely related to the distance between the top floating structure 420 and the bottom plate 415, such that the one or more magnets may exert comparatively less force to couple the top floating structure 420 and the bottom plate 415 as the distance between the top floating structure 420 and the bottom plate 415 increases, and comparatively more force to couple the top floating structure 420 and the bottom plate 415 as the distance between the top floating structure 420 and the bottom plate 415 decreases.

In some cases, the surface 421 may not be directly connected to the top surface 416 and may instead be separated by an alignment device 435 when the semi-floating structure 405 and the fixed structure 410 are coupled. Therefore, the surface 421 is spaced a certain distance from the top surface 416 such that these surfaces are not in direct contact, but may be coupled through one or more other objects or components. The alignment device 435 may be any device that aligns the position of the semi-floating structure 405 with the fixed structure 410 when the semi-floating structure 405 is coupled with the fixed structure 410. For example, the alignment device 435 may align the semi-floating structure 405 to be centered (e.g., concentrically) along the z-direction with the fixed structure 410. Further, the alignment device 435 may align the surface 421 of the top floating structure 420 parallel to the top surface 416 of the bottom plate 415 on the xy-plane.

In some cases, the alignment device 435 may be one of three or more alignment devices 435, where the alignment devices 435 are equally spaced between the semi-floating structure 405 and the fixed structure 410 such that the alignment devices 435 constrain the semi-floating structure against six (6) degrees of freedom when coupled with the fixed structure 410. For example, one alignment device 435 may be a spherical structure on the surface 421 of the top floating structure 420 or connected to the surface 421 of the top floating structure 420. The bottom plate 415 may include a channel 450, a hole, or other similar structure, on the top surface 416 in a position corresponding to the spherical structure and for the spherical structure to align with when the semi-floating structure 405 is coupled with the fixed structure 410.

In some examples, the channel 450 may be one of three or more channels 450, such that each alignment device 435 may be associated with a respective channel 450. The one or more alignment devices 435 may be configured to disengage (e.g., decouple, no longer align) from the respective channels 450 when the external force applied to a bottom surface 426 of the bottom floating plate 425 is greater than the preloading force. Conversely, the alignment device 435 may enable the semi-floating structure 405 to passively align to the fixed structure 410 when the preloading force is applied.

It is understood that the alignment devices 435 and channels 450 may include one or more different structures or devices used to align the top floating structure 420 and the bottom plate 415 when the preloading force is applied, and the examples described herein should not be considered limiting to the disclosure or the claims. For example, the illustrated spherical structures may be located on the top surface 416 of the bottom plate 415, and the channels 450 may be located on the surface 421 of the top floating structure 420, among other examples. Other structures and configurations (e.g., quantity, placement, structure, size) of the alignment devices 435 may be possible.

The semi-floating structure 405 may optionally include a hole 445 (e.g., a cylindrical hole through both the bottom floating plate 425 and the top floating structure 420), which may be used for routing control wiring or other components associated with the robotic manipulator system, the end of arm tooling, or both. The hole 445 may have other shapes or configurations, and may optionally be configured based on one or more applications of the kinematic mount 400 and/or the corresponding robotic manipulator.

The semi-floating structure 405 may mount to end of arm tooling, which may interact with the object, for example, during retrieval and placement. In some cases, as shown in FIG. 4C, a bottom surface 426 of the bottom floating plate 425 may mount to the end of arm tooling. In some examples, the bottom floating plate 425 may comprise three or more kinematic coupling elements 455, which may connect the semi-floating structure 405 to a pick-location plate (e.g., a pick-location plate 220, as described with reference to FIGS. 2A and 2B). In particular, the kinematic coupling elements 455 may be protrusions or recesses on the bottom surface 426 of the bottom floating plate 425 that mate with extensions 230 on the pick-location plate 200. Mating of the kinematic coupling elements 455 with the extensions 230 provides the force on the bottom floating plate 415 that exceeds the preloading force, thus decoupling the semi-floating structure 405 and the fixed structure 410. Conversely, when the kinematic coupling elements 455 are no longer mated with and, thus, no longer in direct attachment with the extensions 230, the semi-floating structure 405 and the fixed structure 410 are coupled so that the relative movement of these components is constrained against six (6) degrees of freedom. When in the mating configuration, the kinematic coupling elements 455 and extension 230 are in direct contact such that the extension 230 is disposed within the protrusion or recess of kinematic coupling element 455. In some embodiments, extensions 230 comprise v-grooves and the kinematic coupling elements 455 are spherical protrusions. Therefore, in these embodiments, the spherical protrusions may rest in the v-grooves.

FIGS. 5A, 5B, and 5C illustrate an example of a kinematic mount 500 that supports techniques for material hand-off using a double-acting kinematic mount in accordance with examples as disclosed herein. The kinematic mount 500 may be an example of the kinematic mount 110, the kinematic mount 210, the kinematic mount 300, and the kinematic mount 400 described with reference to FIGS. 1A, 1B, 2A, 2B, 3A, 3B, 4A, 4B, and 4C. For illustrative purposes, aspects of the kinematic mount 400 may be described with reference to a x-direction, a y-direction, and a z-direction of the illustrated coordinate system. For example, FIG. 5A illustrates a side view of the kinematic mount 500, where the kinematic mount 500 is shown in an xz-plane, with features of the kinematic mount 500 extending some distance along the y-axis (e.g., into the page). FIGS. 5B and 5C illustrate cross-sectional views of the kinematic mount 500, where the kinematic mount 500 is shown in an yz-plane, with features of the kinematic mount 500 extending some distance along the x-axis (e.g., into the page). Although FIGS. 5A, 5B, and 5C illustrate examples of relative dimensions and quantities of various features, aspects of the kinematic mount 500 may be implemented with other relative dimensions or quantities of such features in accordance with examples as disclosed herein. In some aspects, the kinematic mount 500 as described herein may be an intermediate structure that mounts between a flange of a robotic manipulator system and an end of arm tooling for the accurate and efficient retrieval and placement of an object.

The kinematic mount 500 may include a semi-floating structure 505 (e.g., a first sub-component) and a fixed structure 510 (e.g., a second sub-component), which may be examples of a semi-floating structure 305 or 405 and a fixed structure 130, 310, or 410, as described with reference to FIGS. 1B through 4C. The semi-floating structure 505 may include a top floating structure 520 (e.g., a floating structure) and a bottom floating plate 425 (e.g., a first plate) and the fixed structure 510 may include a bottom plate 515 (e.g., a second plate), a housing 511, and a mounting plate 550 (e.g., a robotic mounting plate). The semi-floating structure 505 may be coupled with the end of arm tooling and the fixed structure 510 may be coupled with the flange of a robotic manipulator. In some cases, a bottom surface 526 of the bottom floating plate 525 may include one or more kinematic coupling elements 555 (which may be examples of the kinematic coupling elements 455 described with reference to FIG. 4) for coupling the semi-floating structure 505 to a pick-location plate (e.g., a pick-location plate 220 described with reference to FIGS. 2A and 2B) fixed at a placement (or retrieval location) of an object.

In some examples, as illustrated in FIG. 5B, the semi-floating structure 505 may include a hollow structure (e.g., through the center of the semi-floating structure 405). For instance, the semi-floating structure 505 may optionally include a hole 545 (e.g., a cylindrical hole through both the bottom floating plate 525 and the top floating structure 520), which may be used for routing control wiring or other components associated with the robotic manipulator system, the end of arm tooling, or both. The hole 545 may have other shapes or configurations, and may optionally be configured based on one or more applications of the kinematic mount 500 and/or the corresponding robotic manipulator.

As described herein, a surface 521 of the top floating structure 420 may be coupled with a top surface 516 of the bottom plate 515 via a preloading force, where the preloading force is applied by one or more coupling components 530 (e.g., one or more springs, one or more magnets, one or more other devices, or a combination thereof). In some examples, the coupling components 530 may include three or more mechanical springs such as shown in FIG. 5B. In such cases, each mechanical spring may be attached to the top floating structure 520 and the bottom plate 515 via a pin 531 securing the ends of the of the mechanical spring to the top floating structure 520 and the bottom plate 515 respectively. The mechanical springs may apply the preloading force such that the magnitude of the preloading force is proportional to the distance between the top floating structure 520 and the bottom plate 515. For example, the magnitude of the preloading force may be greater when the distance between the top floating structure 520 and the bottom plate 515 increases.

In other cases, the coupling components 530 may include three or more pairs of coupling magnets, as shown in FIG. 5C. In such cases, each pair of coupling magnets may be attached to the top floating structure 520 and the bottom plate 515 such that the pair of coupling magnets may exert an attractive force towards one another. The pairs of coupling magnets may apply the preloading force such that the magnitude of the preloading force is inversely related to the distance between the top floating structure 520 and the bottom plate 515. For example, the magnitude of the preloading force may be greater when the distance between the top floating structure 520 and the bottom plate 515 decreases. In some aspects, the use of the coupling magnets for the coupling component 530 may enable the semi-floating structure 505 to rotate about an axis (e.g., about the z-axis). In some aspects, the fixed structure 510 may include one or more optional stopping components 565 to prevent the top floating structure 520 from leaving (e.g., along the z-direction) the attractive force (e.g., the magnetic field coupling the magnets) of the pair of magnets.

In some cases, the top floating structure 520 may be aligned with the bottom plate 515 while the preloading force is coupling the semi-floating structure 505 and the fixed structure 510. In some cases one or more alignment devices 535 may align the top floating structure 520 with the bottom plate 515. For example, as illustrated, the one or more alignment devices 535 may include one or more spherical structures in one or more respective channels, grooves, holes, or the like, where the one or more spherical structures may be coupled (e.g., connected or free moving in a pocket) to the surface 521 (e.g., a bottom surface) of the top floating structure 520. In some cases, the one or more respective channels may comprise two parallel pins 553 exposed on the top surface 521 in slots in the bottom plate 515 such that a spherical structure may align in a conceding space formed by the respective curvature of the two pins 553. In other cases, the one or more channels may be v-grooves in the top surface 516 or the surface 521 and the one or more spherical structures may rest in the v-grooves. In some cases, the one or more alignment devices 535 may include three or more alignment devices 535 to constrain the movement of the semi-floating structure 505 from the fixed structure 510. However, a different quantity, orientation, placement, or configuration of the one or more alignment devices may be possible, and the examples described herein should not be considered limiting to the claims or the disclosure.

In some cases, the robotic manipulator system may initialize obtaining and picking up the object using the end of arm tooling. The robotic manipulator system may apply a force on the object via the end of arm tooling to retrieve and pick up the object, which may apply an external force on the end of arm tooling. The end of arm tooling may be coupled with the bottom floating plate 525 such that applying the external force on the end of arm tooling may apply the external force on the bottom surface 526 of the bottom floating plate 525. Furthermore, the retrieval and picking up of the object causes the kinematic coupling elements 455 and the extensions 230 to move from an un-mated configuration to their mated configuration. The external force may be greater than the preloading force, such that the external force may decouple the surface 521 of the top floating structure 520 from the top surface 516 of the bottom plate 515. Decoupling the top floating structure 520 from the bottom plate 515 may enable the semi-floating structure 505 to move independently of the fixed structure 510, which may cause the end of arm tooling to be positioned within a threshold distance of a first location of the object, where the threshold distance may be some distance that is within a predefined and/or indexed location of the object. The robotic manipulator system may obtain the object while the end of arm tooling is within the threshold distance of the first location of the object. In some instances, the threshold distance of the first location may be less than or equal to 1 μm.

In some embodiments, decoupling the top floating structure 520 from the bottom plate 515 allows the components to move further away from each other. For example, the mechanical spring of FIG. 5B may stretch to allow the components to decouple. In the embodiment of FIG. 5C, the external force may be greater than the magnetic pull of magnets 530, thus allowing the magnets to move away from each other (but only within the bounds of stopping component 565). When the top floating structure 520 and the bottom plate 515 are decoupled, the components are able to move independently from each other. For example, the top floating structure 520 may rotate and pivot with regard to the bottom plate 515. Such allows the kinematic mount to have increased degrees of freedom, thus providing for enhanced alignment of the object with its desired placement location. For example, the top floating structure 520 may rotate and pivot with regard to the bottom plate 515, thus causing the bottom floating plate 525 to also rotate and pivot with regard to the bottom plate 515. This movement of the bottom floating plate 525 allows the end of arm tooling 115, and the object connected thereto, to also rotate and pivot. Therefore, the object is able to rotate and pivot not only with respect to the bottom plate 515 but also with regard to the robotic manipulator 105. It is noted that in embodiments, such rotation and pivoting of the top floating structure 520 with regard to the bottom plate 515 is prevented when these components are in the coupled state.

In embodiments, the coupled top floating structure 520 and bottom plate 515 may be referred to a first position of these components. And the decoupled top floating structure 520 and bottom plate 515 may be referred to as a second position of these components. Therefore, the top floating structure 520 and the bottom plate 515 are positioned relatively closer in the first position and relatively further in the second position.

In some cases, the robotic manipulator system may move the object from the first location to a second location after obtaining the object. In some examples, the robotic manipulator system or another peripheral system may perform one or more operations on the object after obtaining the object. In some cases, the robotic manipulator system may stop exerting a force on the object such that the external force may no longer be applied to the bottom surface 526 of the bottom floating plate 525. Movement of the kinematic coupling elements 455 and the extensions 230 to their un-mated state cause termination of the external force on the bottom surface 526. In such cases, termination of the external force may enable the preloading force to recouple the top floating structure 520 with the bottom plate 515, which may realign the semi-floating structure 505 and the fixed structure 510 (e.g., via the alignment devices 535). In some examples, the robotic manipulator system may move the object from the first location to the second location based on the semi-floating structure 505 and the fixed structure 510 being aligned. For example, when the top floating structure 520 is coupled with the bottom plate 515, a frame of reference for the robotic manipulator when moving the object may be the bottom plate 515.

In some cases, the robotic manipulator may apply a second force to the object such that a second external force greater than the preloading force is applied to the bottom surface 526 of the bottom floating plate 525. In some examples, the preloading force may be greater than or equal to a weight of the semi-floating structure 505. Applying the second external force may decouple the surface 521 of the top floating structure 520 from the top surface 516 of the bottom plate 515, thereby positioning the end of arm tooling within a threshold distance of the second location, where the threshold distance may be some distance that is within a predefined and/or indexed location where the object may be placed (e.g., for further processing or manufacturing steps). In some instances, the threshold distance of the second location may be less than or equal to 1 μm. In some examples, the robotic manipulator system may release the object from the end of arm tooling once the end of arm tooling is within the threshold distance of the second location.

FIG. 6 illustrates an example component breakdown of a kinematic mount 600 that supports techniques for material hand-off using a double-acting kinematic mount in accordance with examples as disclosed herein. The kinematic mount 600 may be an example of the kinematic mount 110, the kinematic mount 210, the kinematic mount 300, the kinematic mount 400, or the kinematic mount 500 described with reference to FIGS. 1A, 1B, 2A, 2B, 3A, 3B, 4A, 4B, 4C, 5A, 5B, and 5C. For illustrative purposes, aspects of the kinematic mount 600 may be described with reference to a x-direction, a y-direction, and a z-direction of the illustrated coordinate system. Although FIG. 6 illustrates examples of relative dimensions and quantities of various features, aspects of the kinematic mount 600 may be implemented with other relative dimensions or quantities of such features in accordance with examples as disclosed herein. In some aspects, the kinematic mount 600 as described herein may be an intermediate structure that mounts between a flange of a robotic manipulator system and an end of arm tooling for the accurate and efficient retrieval and placement of an object.

The kinematic mount 600 may include a plurality of components described herein with reference to FIGS. 2A through 5C. The kinematic mount 600 may include a fixed structure and a floating structure, which may be an example of the fixed structure 130, 310, 410, and 510 and the semi-floating structure 305, 405, and 505, as described with reference to FIGS. 1B, 3A, 3B, 4A, and 5A. The fixed structure may include a bottom plate 615 (which may be an example of the bottom plate 140, 315, 415, and 515 described with reference to FIGS. 1B and 2A through 5C), a housing 611 (which may be an example of the housing 145, 311, 411, and 511 described with reference to FIGS. 1B and 2A through 5C), and a mounting plate 650 (which may be an example of the mounting plate 150 or the mounting plate 550 described with reference to FIGS. 1B, 5B, and 5C). In some aspects, where the housing 611 may be connected to the mounting plate 650 and the bottom plate 615 via one or more sets of fasteners. For example, a first set of the fasteners 610-a may secure the mounting plate 650 above (e.g., along the z-direction) the housing 611 and a second set of the fasteners 610-b may secure the housing 611 above the bottom plate 615.

The semi-floating structure may include a top floating structure 620 and a bottom floating plate 625 connected via a third set of fasteners 610-c. The bottom floating plate 625 may be configured to include three or more kinematic coupling elements 655 protruding from a bottom surface of the bottom floating plate 625. The top floating structure 620 may be positioned such that a portion (e.g., a lower cylindrical portion) of the top floating structure 620 extends through a hole 627 in the bottom plate 615 and connects to the bottom floating plate 625 below the bottom plate 615 (e.g., along the z-direction). The top floating structure 620 may be positioned such that an upper portion of the top floating structure 620 is above (e.g., along the z-direction) the bottom plate 615 and surrounded by the housing 611 (e.g., along the xy-plane).

The kinematic mount 600 may include coupling components 630 configured to couple the floating structure with the fixed structure. For example, three or more coupling components 630 may be attached to the top floating structure 620 and the bottom plate 615 via pins 631 through the top floating structure 620 and the bottom plate 615, respectively. In some cases, the coupling components 630 may extend at least partially into the top floating structure 620 and the bottom plate 615 along the z-direction.

The kinematic mount 600 may include alignment devices 635 configured to align the floating structure with the fixed structure. For example, three or more alignment devices 635 may be configured to sit in grooves (e.g., channels) created by parallel alignment pins 653. The parallel alignment pins 653 may extend at least partially through the bottom plate 615 in the xy-plane and the space between the parallel alignment pins 653 may create the grooves in which the alignment devices 635 may sit. The alignment devices 635 may be housed by the top floating structure 620 and may align the top floating structure 620 to the bottom plate 615.

The kinematic mount 600 may be connected to the robotic manipulator and the end of arm tooling via one or more fastening methods. For example, the kinematic mount 600 may be secured to the robotic manipulator system via mechanical fasteners (e.g., screws), and the kinematic mount 600 may be secured to the end of arm tooling via mechanical fasteners (e.g., screws). In some cases, the kinematic mount 600 may be temporarily coupled to the robotic manipulator system and the end of arm tooling via magnets, vacuum force, or mechanical means, such that at a later time the kinematic mount 600 may be more permanently secured to the robotic manipulator system and the end of arm tooling.

In accordance with examples as described herein, the kinematic mount 600 may mitigate errors associated with performing retrieval and placement of the object. For example, tolerance errors associated with a predetermined location of the object may not be propagated to subsequent stages of processing because the decoupling of the kinematic mount 600 may mitigate the errors and provide improved accuracy for object placement and/or retrieval. Further, the kinematic mount 600 may allow the robotic manipulator system to have high accuracy and high efficiency. For example, the kinematic mount 600 may support positional accuracy up to ±1 μm due to the self-aligning mechanics of the kinematic mount 600, while maintaining the speed, production volume, and efficiency associated with low accuracy methods (e.g., fixed location operation) due to negating performing visual servoing. In some implementations, operation of the kinematic mount 600 may improve positional accuracy by 100 times (e.g., compared to fixed location operation), without causing an increase to time or power consumption.

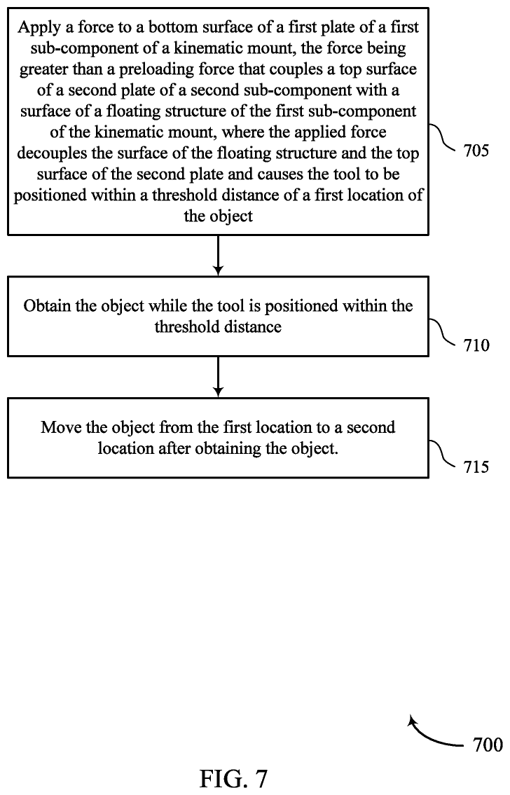

FIG. 7 shows a flowchart illustrating a method 700 that supports techniques for material hand-off using a double-acting kinematic mount in accordance with examples as disclosed herein. The operations of the method 700 may be implemented by a system or its components as described herein. For example, the operations of the method 700 may be performed by a system configured for accurate and efficient retrieval and placement of an object using a double-acting kinematic mount, as described with reference to FIGS. 1A, 1B, 2A, 2B, 3A, 3B, 4A, 4B, 4C, 5A, 5B, 5C, and 6. In some examples, a device may execute a set of instructions to control the functional elements of the device to perform the described functions. Additionally, or alternatively, the device may perform aspects of the described functions using special-purpose hardware.

At 705, the method may include obtaining an object using a tool that is coupled (e.g., mechanically coupled) with a kinematic mount, the kinematic mount including a first sub-component and a second sub-component. Obtaining the object includes: applying a force to a bottom surface of a first plate of the first sub-component, the force being greater than a preloading force that couples a top surface of a second plate of the second sub-component with a surface of a floating structure of the first sub-component, where the applied force decouples the surface of the floating structure and the top surface of the second plate and causes the tool to be positioned within a threshold distance of a first location of the object. The operations of 705 may be performed in accordance with examples as disclosed herein.

At 710, the method may include obtaining the object while the tool is positioned within the threshold distance. The operations of 710 may be performed in accordance with examples as disclosed herein.

At 715, the method may include moving the object from the first location to a second location after obtaining the object. The operations of 715 may be performed in accordance with examples as disclosed herein.

In some examples, an apparatus as described herein may perform a method or methods, such as the method 700. The apparatus may include, features, circuitry, logic, means, or instructions (e.g., a non-transitory computer-readable medium storing instructions executable by a processor) for obtaining an object using a tool that is coupled with a kinematic mount. In some examples, the kinematic mount may include a first sub-component and a second sub-component, where obtaining the object includes applying a force to a bottom surface of a first plate of the first sub-component, the force being greater than a preloading force that couples a top surface of a second plate of the second sub-component with a surface of a floating structure of the first sub-component, where the applied force decouples the surface of the floating structure and the top surface of the second plate and causes the tool to be positioned within a threshold distance of a first location of the object. In some examples of the method 700 and the apparatus described herein, the apparatus may include operations, features, circuitry, logic, means, or instructions for obtaining the object while the tool is positioned within the threshold distance, and moving the object from the first location to a second location after obtaining the object. In some examples of the method 700 and the apparatus described herein, the threshold distance of the first location is less than or equal to one micrometer.

In some examples of the method 700 and the apparatus described herein, the apparatus may include operations, features, circuitry, logic, means, or instructions for removing the force from the bottom surface of the first plate after obtaining the object, where removing the force causes the surface of the floating structure to couple with the top surface of the second plate, where the object is moved from the first location to the second location based on the surface of the floating structure being coupled with the top surface of the second plate. In some cases, the second plate of the second sub-component is a frame of reference for moving the object when the surface of the floating structure is coupled with the top surface of the second plate.

In some examples of the method 700 and the apparatus described herein, the apparatus may include operations, features, circuitry, logic, means, or instructions for applying a second force to the bottom surface of the first plate to cause the surface of the floating structure to decouple from the top surface of the second plate and position the tool within a threshold distance of the second location, the second force being greater than the preloading force; and releasing the object from the tool based on the tool being positioned within the threshold distance of the second location. In some cases, the threshold distance of the second location is less than or equal to one micrometer.

In some examples of the method 700 and the apparatus described herein, the surface of the floating structure is coupled with the top surface of the second plate based on two or more pins on the surface of the floating structure or on the top surface of the second plate and one or more balls on the top surface of the second plate or on the surface of the floating structure, each pair of pins of the two or more pins being aligned with a respective ball of the one or more balls when the surface of the floating structure is coupled with the top surface of the second plate based on the preloading force.

In some examples of the method 700 and the apparatus described herein, the surface of the floating structure is coupled with the top surface of the second plate based on one or more v-grooves on the surface of the floating structure or on the top surface of the second plate and one or more balls on the top surface of the second plate or on the surface of the floating structure, each v-groove of the one or more v-grooves being aligned with a respective ball of the one or more balls when the surface of the floating structure is coupled with the top surface of the second plate based on the preloading force.

In some examples of the method 700 and the apparatus described herein, the bottom surface of the first plate includes one or more kinematic coupling elements, the tool being coupled with the bottom surface of the first plate via mechanical mounting. In some implementations, the one or more kinematic coupling elements include a set of spherical coupling elements, a set of grooved coupling elements, a set of toothed coupling elements, or any combination thereof.

An apparatus is described. The apparatus may include a first sub-component that includes a first plate coupled with a floating structure, a second sub-component that at least partially surrounds the floating structure and includes a second plate, and one or more coupling components that are configured to apply a preloading force to the first sub-component and the second sub-component, the preloading force for coupling a surface of the floating structure with a top surface of the second plate, where the surface and the top surface are configured to decouple when a force greater than the preloading force is applied to a bottom surface of the first plate.

In some examples of the apparatus, the first sub-component is configured to move independent of the second sub-component with a plurality of degrees of freedom when the surface of the floating structure and the top surface of the second plate are decoupled. In some examples of the apparatus, the first sub-component is configured to rotate with respect to the second sub-component when the surface of the floating structure and the top surface of the second plate are decoupled.

In some examples of the apparatus, the surface of the floating structure includes one or more spherical structures that are each aligned with respective channels of the top surface of the second plate when the surface of the floating structure is coupled with a top surface of the second plate, the one or more spherical structures being configured to disengage from the respective channels when the force greater than the preloading force is applied to the bottom surface of the first plate. In some examples of the apparatus, the one or more coupling components include one or more springs, one or more magnets, or any combination thereof. In some examples of the apparatus, the preloading force is greater than or equal to a weight of the first sub-component. In some examples of the apparatus, the first plate coupled with the floating structure is a solid body structure.

A system is described. The system may include a robotic manipulator, a kinematic mount including a first sub-component and a second sub-component that is coupled with the robotic manipulator, the first sub-component configured to move relative to the second sub-component when a force is applied to a surface of a first plate of the first sub-component, the force being greater than a preloading force that couples a surface of a second plate of the second sub-component with a surface of a floating structure of the first sub-component. In some examples, the system may include a tool coupled with the kinematic mount via a mechanical mounting (e.g., a mechanical coupling). In some examples of the system, the tool may be configured to be positioned, by the robotic manipulator, within a threshold distance from an object based on the first sub-component moving relative to the second sub-component, and to obtain the object based on the position of the tool.

In some examples of the system, the robotic manipulator may be configured to move the object from a first location to a second location after the object is obtained by the tool, where the tool is positioned by the robotic manipulator within a threshold distance of the second location based on the first sub-component moving relative to the second sub-component when a second force that is greater than the preloading force is applied to the surface of the first plate.

In some examples of the system, the second plate of the second sub-component corresponds to a fixed frame of reference for the robotic arm when the preloading force couples the surface of the floating structure of the first sub-component with the surface of the second plate of the second sub-component.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a digital signal processor (DSP), a central processing unit (CPU), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
obtaining an object with a tool that is coupled with a kinematic mount, the kinematic mount comprising a first sub-component and a second sub-component, wherein obtaining the object comprises:
applying a force to a bottom surface of a first plate of the first sub-component, the force being greater than a preloading force that couples a second plate of the second sub-component with a floating structure of the first sub-component, wherein the applied force decouples the floating structure and the second plate and causes the tool to be positioned within a threshold distance of a first location of the object; and
engaging the object with the tool while the tool is positioned within the threshold distance; and
moving the object from the first location to a second location after obtaining the object.

2. The method of claim 1, further comprising:
removing the force from the bottom surface of the first plate after obtaining the object, wherein removing the force causes the floating structure to couple with the second plate.

3. The method of claim 2, wherein the floating structure and the second plate are relatively further away when decoupled and are relatively closer when coupled.

4. The method of claim 2, further comprising:
applying a second force to the bottom surface of the first plate to cause the floating structure to decouple from the second plate and to position the tool within a threshold distance of the second location, the second force being greater than the preloading force; and
releasing the object from the tool based at least in part on the tool being positioned within the threshold distance of the second location.

5. The method of claim 4, wherein the threshold distance of the second location is less than or equal to one micrometer.

6. The method of claim 1, wherein the threshold distance of the first location is less than or equal to one micrometer.

7. The method of claim 1, wherein the object is positioned on a plate, the plate comprising an extension, the method further comprising providing a mating attachment between the extension and a recess on the first plate to apply the force to the bottom surface of the first plate.

8. The method of claim 7, wherein providing the mating attachment comprises the extension being disposed within the recess such that the extension and recess and are directly connected.

9. The method of claim 1, wherein the bottom surface of the first plate comprises one or more kinematic coupling elements and the tool is coupled with the bottom surface of the first plate via a mechanical mounting.

10. The method of claim 9, wherein the one or more kinematic coupling elements comprise a set of spherical coupling elements, a set of grooved coupling elements, a set of toothed coupling elements, or any combination thereof.

11. A kinematic mount, comprising:
a first sub-component that comprises a first plate and a floating structure;
a second sub-component that at least partially surrounds the floating structure and that comprises a second plate, the second plate being concentric with the first plate; and
one or more coupling components configured to move the floating structure and the second plate from a first position to a second position,
the floating structure and the second plate being relatively closer in the first position and being relatively further in the second position,
the floating structure and the second plate being configured to move independently of each other in the second position but not in the first position, and
the one or more coupling components providing a preloading force on the floating structure and the second plate in the first position,
wherein the floating structure and the second plate are configured to decouple when a force greater than the preloading force is applied to the first plate.

12. The kinematic mount of claim 11, wherein the first sub-component is configured to move independent of the second sub-component with a plurality of degrees of freedom when the floating structure and the second plate are in the second position.

13. The kinematic mount of claim 12, wherein the first sub-component is configured to rotate with respect to the second sub-component when the floating structure and the second plate are in the second position.

14. The kinematic mount of claim 11, wherein a surface of the floating structure comprises one or more spherical structures that are each aligned with respective channels of a top surface of the second plate when the floating structure and the second plate are in the second position, the one or more spherical structures being configured to disengage from the respective channels when the force greater than the preloading force is applied to the first plate.

15. The kinematic mount of claim 11, wherein the one or more coupling components comprise one or more springs, one or more magnets, or any combination thereof.

16. The kinematic mount of claim 11, wherein the preloading force is greater than or equal to a weight of the first sub-component.

17. The kinematic mount of claim 11, further comprising a central hole disposed within the first plate and the floating structure.

18. A system, comprising:
a robotic manipulator;
a kinematic mount comprising a first sub-component and a second sub-component that is coupled with the robotic manipulator, the first sub-component configured to move relative to the second sub-component when a force is applied to a surface of a first plate of the first sub-component, the force being greater than a preloading force that couples a surface of a second plate of the second sub-component with a surface of a floating structure of the first sub-component; and
a tool coupled with the kinematic mount via a mechanical mounting, wherein the tool is configured to:
be positioned, by the robotic manipulator, within a threshold distance from an object based at least in part on the first sub-component moving relative to the second sub-component, and
obtain the object based at least in part on the position of the tool.

19. The system of claim 18, wherein the robotic manipulator is configured to move the object from a first location to a second location after the object is obtained by the tool, wherein the tool is positioned by the robotic manipulator within a threshold distance of the second location based at least in part on the first sub-component moving relative to the second sub-component when a second force that is greater than the preloading force is applied to the surface of the first plate.

20. The system of claim 18, wherein the second plate of the second sub-component corresponds to a fixed frame of reference for the robotic manipulator when the preloading force couples the surface of the floating structure of the first sub-component with the surface of the second plate of the second sub-component.
